(19) United States
(12) Patent Application Publication
(10) Pub. No.: US 2015/0321219 A1
(43) Pub. Date: Nov. 12, 2015

(54) INORGANIC MICROFILM COATED SUBSTRATE AND METHOD THEREOF

(71) Applicant: WARAPON HONGTANSAWAT, Samutprakarn (TH)

(72) Inventors: WARAPON HONGTANSAWAT, Samutprakarn (TH); CHIA-LIN LIU, Tainan City (TW)

(21) Appl. No.: 14/310,810

(22) Filed: Jun. 20, 2014

(30) Foreign Application Priority Data
May 9, 2014 (TW) 103116493

(51) Int. Cl. B05D 3/02; C08K 5/3417; C08K 3/34; C08K 3/22; C09D 1/00; C08K 3/36

(52) U.S. Cl. CPC B05D 3/0254; C09D 1/00; C08K 3/36; C08K 3/34; C08K 3/22; C08K 5/3417; C08K 2003/2296; C08K 2003/2265; C08K 2003/2203; C08K 2003/2227

(57) ABSTRACT

An inorganic microfilm coated substrate and a method thereof. The inorganic microfilm coated substrate includes a substrate; and an inorganic microfilm layer, disposed on the substrate and being an inorganic microfilm composition, wherein the inorganic microfilm composition comprising: a silicon oxide ion solution; a lithium ion solution; and a potassium ion solution, wherein the silicon oxide ion solution, the lithium ion solution, and the potassium ion solution are mixed together to form the inorganic microfilm composition. The method for making an inorganic microfilm coated substrate includes the steps of providing a substrate and surface property of the substrate is modified by using an inorganic acid salt; and proving an inorganic microfilm composition, and the inorganic microfilm composition is coated on the substrate, and then baked to form an inorganic microfilm layer.

### CROSS-REFERENCE TO RELATED APPLICATION

This application claims the benefit of Taiwan Patent Application No. 103116493, filed on May 9, 2014, which is hereby incorporated by reference for all purposes as if fully set forth herein.

### BACKGROUND

1. Field of the Invention

The present invention relates to a substrate coated with inorganic microfilms and a method thereof, and more particularly to an inorganic microfilm coated substrate without using an anodizing process and a method thereof.

2. Brief Description of the Related Art

Nowadays, IT products are rapidly developed and the demands of IT products are increased as well. In addition, the shell of most high-end IT products is made of the materials such as aluminum, magnesium, etc. due to the effects of aesthetic feeling, quality, and high heat-dissipation, so that those materials are used as a first choice for IT products' shell.

However, in order to have more aesthetic feeling and enhance the surface hardness of the shell made of aluminum (Al), magnesium (Mg), etc., a surface treatment must be performed. The surface treatment or the surface finishing is a processing technology, which is mainly used to change the physical and chemical properties of metal surface, for example, Al, Mg, etc., and its purpose is to improve corrosion-resistant, wear-resistant, heat-resist of materials to prolong life span and increase luster so as to aesthetic feeling and quality of products.

During the surface treatment process, the metal surface may be coated with a protective film. The materials of the protective film may include metal, glass, ceramic and a conversion coating film by using a phosphorylation or anodizing process, and the surface treatment is performed through a chemical or electrochemical process to make the metal surface grow a film layer containing metal components. Further, each of protective films has its character and use limitation, for instance, the ceramic protective film may have the properties of heat-resist and acid resistant, but it is unable to endure collision because the ceramic is a fragile material. And, the anodizing process may be applied to metal materials such as Al, so that the metal materials may be protected by oxide films.

Therefore, the anodizing process becomes a main trend of metal surface treatment technology. The anodizing process is a process through which metal articles may be dyed. For example, the anodizing is a process in which a metal workpiece, such as Al or Al alloy, is disposed in the anode terminal of an electrolytic bath, and a certain voltage and current is applied such that the surface of the metal workpiece forms an oxide layer. However, since Al alloy is easily oxidized, the oxide layer may provide a certain protection. But, the oxide layer may peel after a period of time of exposure and loss the protection function gradually. Therefore, the anodizing process uses an electrochemical method to control the oxidization generated on the surface of Al material and also increase physical properties such as mechanical property. In addition, it may also enhance the appearance by dying colors through different chemical formation reactions to enhance appearance.

The anodizing process is widely applied to, for example, IT products, handrails, windows and so on made of Al or Al alloy.

However, with the rising of environmental awareness in recent years, the standard for industrial waste disposal is increased as well. Therefore, it is a critical challenge for anodizing process which produces a large amount of waste water because a large amount of electrolytic solution is used during the process.

### SUMMARY

In order to solve the abovementioned problems, a surface treatment without using an anodizing process is provided, in which an inorganic microfilm composition is coated on the surface of a substrate to form the inorganic microfilm layer so as to replace the anodizing process.

The present invention discloses an inorganic microfilm coated substrate including: a substrate and an inorganic microfilm layer. The inorganic microfilm layer is on the substrate, and the inorganic microfilm layer is an inorganic microfilm composition. In addition, the inorganic microfilm composition includes a silicon oxide ion solution; a lithium ion solution and a potassium ion solution, wherein the silicon oxide ion solution, the lithium ion solution and the potassium ion solution are mixed together to form the inorganic microfilm composition.

The present invention discloses a method for making an inorganic microfilm coated substrate, including: providing a substrate, wherein the surface of the substrate is modified by an inorganic acid salt; and providing an inorganic microfilm composition, wherein the inorganic microfilm composition is coated on the inorganic microfilm composition and then baked into an inorganic microfilm layer.

The physical and chemical properties of the inorganic microfilm coated substrate of the present invention are better than that of the substrate processed by anodizing. Therefore, the present invention can be used to replace the anodizing process which requires a large amount of electrolytic solution and the method of the present invention is environmental friendly.

### BRIEF DESCRIPTION OF THE DRAWINGS

FIG. 1 is a structure diagram of an inorganic microfilm coated substrate according to the present invention; and

FIG. 2 is a flowchart of the inorganic microfilm coated substrate according to the present invention.

### DETAILED DESCRIPTION OF THE EMBODIMENTS

Hereinafter, the preferred embodiment of the present invention will be described in detail with reference to the accompanying drawings, to describe the structure and features of the present invention. It will be understood that the following description is not intended to limit the invention to the form disclosed herein.

Hereinafter, the embodiments of the inorganic microfilm coated substrate and the method thereof will be detailed explanation.

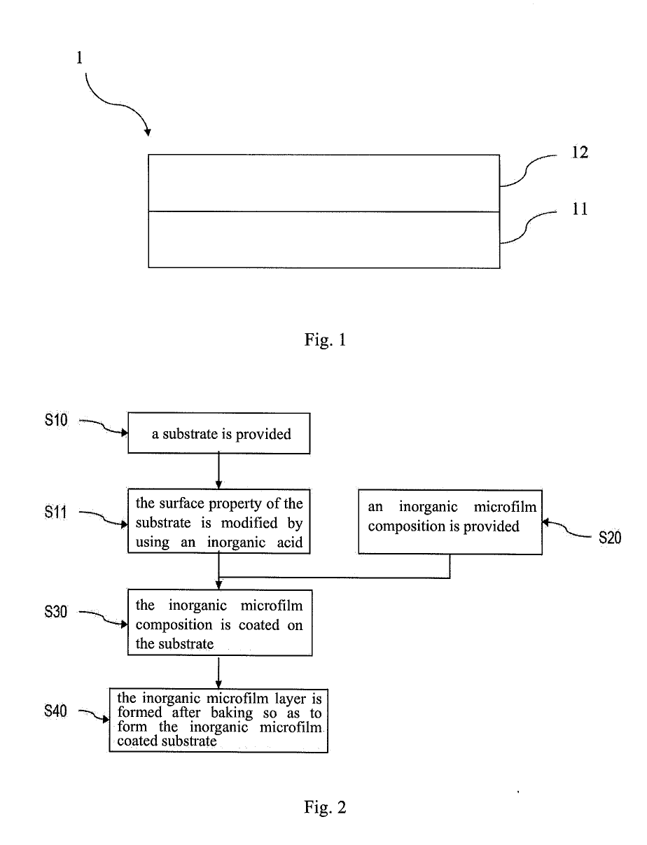

Please refer to FIG. 1, FIG. 1 is a structure diagram of the inorganic microfilm coated substrate. The inorganic microfilm coated substrate 1 according to the present invention may include a substrate 11 and an inorganic microfilm layer 12. The inorganic microfilm layer 12 is on the substrate 11, and the inorganic microfilm layer 12 is made of an inorganic microfilm composition. The inorganic microfilm composition may include a silicon oxide ion solution, a lithium ion solution, and a potassium ion solution, wherein the silicon oxide ion solution, the lithium ion solution, and the potassium ion solution are uniformly mixed together to form the inorganic microfilm composition. The substrate 11 may include a material selected from a group consisting of aluminum (Al), magnesium (Mg), titanium (Ti), copper (Cu), iron (Fe), lithium (Li), glass and ceramic. The lithium ion solution may be a Li2SiO3 solution, and the Li4SiO4 solution may be composed of SiO2 and Li2O. Young's modulus (ratio of molecules) of SiO2 and Li2O may be between 2 and 12, and Young's modulus of SiO2 and Li2O may preferably be between 2 and 4. The potassium ion solution may be K2SiO3 solution, and K2SiO3 solution may be composed of SiO2 and K2O. Young's modulus of SiO2 and K2O may be between 2 and 12, and Young's modulus of SiO2 and K2O may preferably be between 2 and 4. Young's modulus of K2O and Li2O may be between 0.25 and 4. The inorganic microfilm composition may further include dyes, and dyes may be selected from a group consisting of titanium oxide, zinc oxide, carbon black, iron oxide black, manganese iron black, cobalt blue, copper phthalocyanine, iron blue, transparent iron oxide, cobalt green, iron oxide yellow, and iron oxide red.

The inorganic microfilm composition may be stored under room temperature for at least three years without being deteriorated, and has a stable chemical property.

The inorganic microfilm composition may be diluted by adding water in order to control the concentration of inorganic microfilm composition, which depends on the requirements of the coating process such as spray coating, electrostatic spraying, dip coating, rolling coating or spin coating and so on.

Please refer to FIG. 2. FIG. 2 is a flowchart for making the inorganic microfilm coated substrate according to the present invention. The method for making an inorganic microfilm coated substrate 1 may include the steps of: proving a substrate 11 (S10), wherein the surface property of the substrate 11 is modified by using an inorganic acid salt (S11), and providing an inorganic microfilm composition (S20), wherein the inorganic microfilm composition is coated on the substrate 11 (S30), and then baked into an inorganic microfilm layer 12 so as to form the inorganic microfilm coated substrate 1 (S40). The inorganic acid salt may be selected from a group consisting of H3AlO3 and silicate.

### Embodiment 1

Pure water 1000 g (that is, 1000 ml) and Li2O 20 g are poured into a first stirred tank, and then they are mixed by high speed stirring under room-temperature so as to form a Li2O solution.

A SiO2 solution 300 g is poured into a second stirred tank, and the second stirred tank is placed in a water tank with the temperature of 40-80° C., and the temperature of SiO2 solution in the second stirred tank is heated to 30-70° C. by a hydrothermal synthesis such that SiO2 solution changes into a form of sol.

The Li2O solution in the first stirred tank is slowly poured into the second stirred tank with keeping continuously high speed stirring and also maintaining the temperature of the second stirred tank within 30-70° C. so as to form a Li2SiO3 solution.

A K2SiO3 solution 500 g with Young's modulus between 2 and 6 of SiO2 and K2O is poured into a third stirred tank, and the K2SiO3 solution is heated to a temperature of 30-70° C.

A Li2SiO3 solution in the second stirred tank is poured into the third stirred tank, and maintains temperature of the third stirred tank at about 60° C. Then, Li2SiO3 solution and K2SiO3 solution are stirred with high speed until the Li2SiO3 solution and K2SiO3 solution in the third stirred tank become transparent, and then a filter screen with less than 5 holes is used for filtering. Next, the amount of water loss is calculated, and then the amount of loss water is replenished by pure water until reaching the original total weight of 1820 g (pure water 1000 g, Li2O 20 g, SiO2 solution 300 g and K2SiO3 solution 500 g), so as to form the inorganic microfilm composition according to the first embodiment of the present application.

The inorganic microfilm composition according to the first embodiment of the present application is transparent.

### Embodiment 2

A K2SiO3 solution 500 g with Young's modulus between 2 and 6 of SiO2 and K2O is poured into a first stirred tank, and the K2SiO3 solution is heated to a temperature of 30-70° C.

Pure water 1000 g and Li2O 20 g are poured into a second stirred tank, and then they are mixed by high speed stirring under room-temperature to form a Li2O solution.

A SiO2 solution 300 g is poured into a third stirred tank, and the third stirred tank is placed in a water tank with the temperature of 40-80° C., and the temperature of SiO2 solution in the third stirred tank is heated to 30-70° C. by a hydrothermal synthesis such that SiO2 solution changes into a form of sol.

The K2SiO3 solution in the first stirred tank and the Li2O solution in the second stirred tank are slowly pour into a third stirred tank in sequence, and then they are mixed by continuously high speed stirring and also maintaining the temperature of the third stirred tank at about 60° C. until the solution in the third stirred tank into transparent, and then a filter screen with less than 5 μm holes is used for filtering. Next, the amount of water loss is calculated, and then the amount of loss water is replenished by pure water until reaching the original total weight of 1820 g (K2SiO3 solution 500 g, pure water 1000 g, Li2O 20 g, and SiO2 solution 300 g), so as to form the inorganic microfilm composition according to the second embodiment of the present application.

The inorganic microfilm composition according to the second embodiment of the present application is transparent.

### Embodiment 3

A SiO2 solution 300 g is poured into a first stirred tank, and the first stirred tank is placed in a water tank with the temperature of 40-80° C., and the temperature of SiO2 solution in the first stirred tank is heated to 30-70° C. by a hydrothermal synthesis such that SiO2 solution changes into a form of sol.

A K2SiO3 solution 500 g with Young's modulus between 2 and 6 of SiO2 and K2O is poured into a second stirred tank, and the K2SiO3 solution is heated to a temperature of 30-70° C.

Pure water 1000 ml and Li2O 20 g are poured into a third stirred tank, and then they are mixed by high speed stirring under room-temperature so as to form a Li2O solution.

The SiO2 solution in the first stirred tank and the K2SiO3 solution in the second stirred tank are slowly pour into a third stirred tank in sequence, and then they are mixed by continuously high speed stirring and also maintaining the temperature of the third stirred tank at about 60° C. until the solution in the third stirred tank into transparent, and then a filter screen with less than 5 μm holes is used for filtering. Next, the amount of water loss is calculated, and then the amount of loss water is replenished by pure water until reaching the original total weight of 1820 g (SiO2 solution 300 g, K2SiO3 solution 500 g, pure water 1000 g, and Li2O 20 g), so as to form the inorganic microfilm composition according to the third embodiment of the present application.

The inorganic microfilm composition according to the third embodiment of the present application is transparent.

Through the experiments, the inorganic microfilm composition of the first embodiment, the inorganic microfilm composition of the second embodiment, and the inorganic microfilm composition of the third embodiment have the same physical and chemical properties, which proves that the sequence of adding SiO2 solution 300 g, K2SiO3 solution 500 g and Li2O 20 g would not affect the property of the product.

### Embodiment 4

A white titanium oxide (TiO2) powder is used as dye, and the diameter of TiO2 powder is about 0.2-1 μm. Next, deionizing (DI) water is poured into the TiO2 powder to disperse the TiO2 powder, and then a conventional dispersion made of PMAA is used for assisting the dispersion of the TiO2 powder. Also, a homogenizer with high speed stirring 10-60 minutes is used to disperse the TiO2 powder in order to obtain a TiO2 solution.

Next, the TiO2 solution is added into the inorganic microfilm composition of the first embodiment, and then a homogeneous stirring is performed to form an (white) inorganic microfilm composition of the fourth embodiment.

The inorganic microfilm composition according to the fourth embodiment of the present application is white color.

### Embodiment 5

In a Class 50000 clean room, a stainless steel substrate is provided, and then a silicate is used to modify the surface properties of the stainless steel substrate. Next, pure water is used to clean the stainless steel substrate and then bake the stainless steel substrate in order to obtain a clean stainless steel substrate.

Next, the inorganic microfilm composition of the first embodiment is coated on the stainless steel substrate by conventional coating means to form a film thickness of about 0.2-2 μm. Then, the stainless steel substrate is put into an oven and baked with the temperature of 150-300° C. for 0.1-1 hr to form the inorganic microfilm layer on the stainless steel substrate, so as to form the inorganic microfilm coated substrate of the fifth embodiment.

The inorganic microfilm layer on the inorganic microfilm coated substrate according to the fifth embodiment of the present application is a transparent layer.

### Embodiment 6

In a Class 50000 clean room, a stainless steel substrate is provided, and then a silicate is used to modify the surface properties of the stainless steel substrate. Next, pure water is used to clean the stainless steel substrate and then bake the stainless steel substrate in order to obtain a clean stainless steel substrate.

Next, the inorganic microfilm composition of the first embodiment is coated on the surface of the stainless steel substrate by conventional coating means, and then they are dried under room temperature so as to form a film thickness of about 0.2-2 μm.

The (white) inorganic microfilm composition of the fourth embodiment is coated on the surface of the stainless steel substrate by conventional coating means, and then they are dried under room temperature so as to form a film thickness of about 3-20 μm.

The inorganic microfilm composition of the first embodiment is coated on the surface of the stainless steel substrate by conventional coating means, and then they are dried under room temperature so as to form a film thickness of about 0.2-2 μm.

Next, the coated stainless steel substrate is put into an oven and baked with the temperature of 150-300° C. for 0.1-1 hr to form the (white) inorganic microfilm layer on the stainless steel substrate, so as to form the inorganic microfilm coated substrate of the sixth embodiment.

The inorganic microfilm coated substrate according to the sixth embodiment of the present invention has a three-layer film structure. The surface of the stainless steel substrate has a (transparent) inorganic microfilm layer, and a white inorganic microfilm layer on the (transparent) inorganic microfilm layer, and a (transparent) inorganic microfilm layer (the outer layer) on the white inorganic microfilm layer such that a (white) inorganic microfilm coated substrate of the sixth embodiment may have a porcelain luster.

### Embodiment 7

In a Class 50000 clean room, a stainless steel substrate is provided, and then a silicate is used to modify the surface properties of the stainless steel substrate. Next, pure water is used to clean the stainless steel substrate and then bake the stainless steel substrate in order to obtain a clean stainless steel substrate.

The inorganic microfilm composition of the first embodiment is coated on the surface of the stainless steel substrate by conventional coating means, and then they are dried under room temperature so as to form a film thickness of about 3 μm of the first layer.

The inorganic microfilm composition of the first embodiment is coated on the first layer by conventional coating means, and then they are dried under room temperature so as to form a film thickness of about 3 μm of the second layer.

The inorganic microfilm composition of the first embodiment is coated on the second layer by conventional coating means, and then they are dried under room temperature so as to form a film thickness of about 3 μm of the third layer.

Next, the coated stainless steel substrate is put into an oven and baked with the temperature of 150-300° C. for 0.1-1 hr to form the inorganic microfilm layers on the stainless steel substrate, so as to form the inorganic microfilm coated substrate of the seventh embodiment.

The inorganic microfilm coated substrate according to the seventh embodiment of the present invention has a three-layer film structure. The top surface of the stainless steel substrate has three transparent inorganic microfilm layers such that an inorganic microfilm coated substrate of the seventh embodiment may have a primitive color of stainless steel.

Hereafter, the inorganic microfilm coated substrate according to the seventh embodiment of the present application is tested by using conventional methods. In the tests, the inorganic microfilm coated substrate will be examined whether the appearance is flatness, color is transparent, primitive color of stainless steel is appeared, and luster is brightness; weight, ratio of nonvolatile, and coating rate of the inorganic micro coating film will be measured; in addition, a cross-cut tape adhesion test is used to test adhesive strength; furthermore, salt water (5% concentration) is sprayed on the substrate for 500 hrs for testing anti-salt mist corrosion; a non-woven cloth dipped with 95% ethanol, acetone, methyl ethyl ketone, toluene and isopropyl alcohol is used to wipe the substrate 100 times for testing solvent-resistant; the inorganic microfilm coated substrate is immersed into distilled water with 30° C. for 24 hrs for testing waterproof; the inorganic microfilm coated substrate is immersed into salt water (5% concentration) for 720 hrs for testing salt tolerance; the inorganic microfilm coated substrate is immersed into 1M sulfuric acid for 24 hrs and immersed into hydrochloric acid (30% concentration) for 24 hrs for testing acidproof; the inorganic microfilm coated substrate is immersed into NaOH (5% concentration) for 24 hrs, and immersed into ammonia for 24 hrs for testing alkaliproof; a non-woven cloth dipped dishwasher detergent is used to wipe the inorganic microfilm coated substrate 100 times for testing anti-detergent; the inorganic microfilm coated substrate is placed in a 500° C. environment for 1 hr for testing heat-resist; a wear-resistant machine loaded with 280 g is used to rub the inorganic microfilm coated substrate 10000 times for testing wear-resistant; the inorganic microfilm coated substrate is irradiated by ultraviolet ray for 24 hrs for testing anti-yellowing; the inorganic microfilm coated substrate is immersed into cooking oil for 24 hrs, and soy sauce for 24 hrs for testing anti oil stain, and the results are shown in Table 1:

TABLE 1

| Item | Results |
|---|---|
| appearance | flatness |
| color | transparent |
| luster | brightness |
| weight (kg/l) | 1.05 |
| nonvolatile (%) | 20 |
| coating rate (m²/kg) | 60 |
| adhesion | 100% no peeling |
| anti-salt mist | pass |

| | | |
|---|---|---|
| solvent-resistant | ethanol | pass |
| | acetone | pass |
| | methyl ethyl | pass |
| | ketone | |
| | toluene | pass |
| | isopropyl | pass |
| | alcohol | |
| waterproof | bump | no bump, no blister |
| | luster hue | no change |

| | |
|---|---|
| salt tolerance | pass |

| | | |
|---|---|---|
| acidproof | H2SO4 | pass |
| | HCl | pass |
| alkaliproof | NaOH | pass |
| | ammonia | pass |

| | |
|---|---|
| anti-detergent | pass |
| heat-resist | pass |
| wear-resistant | pass |
| anti-yellowing | pass |

| | | |
|---|---|---|
| anti oil stain | cooking oil | pass |
| | soy sauce | pass |

From the table 1, the inorganic microfilm coated substrate of the seventh embodiment passes all of the required tests and can be applied to all of business standard relating to this technical field.

Further, the hardness and the film thickness of both the inorganic microfilm coated substrate of the seventh embodiment (hereafter called the microfilm coated substrate) and the substrate processed by an anodizing process (hereafter called the anodizing processed substrate) are tested and compared. Marks are drawn on the surfaces of both the microfilm coated substrate and the anodizing processed substrate by using an oil-based mark pen, and after 2 minutes, clean water is used to clean the marks so as to test whether it is easily be cleaned and whether detergent is used during the process, or whether a large amount of electrolytic solution, which causes environmental pollution, is used; salt water (5% concentration) is sprayed on both substrates for testing anti-salt mist corrosion. The microfilm coated substrate of the present application passes a 500 hrs test, but the anodizing processed substrate fails at 100 hrs; a non-woven cloth dipped with 95% ethanol, acetone, methyl ethyl ketone, toluene and isopropyl alcohol is used to wipe each substrate 100 times for testing solvent-resistant; both substrates are immersed into 1M sulfuric acid for 24 hrs for testing acidproof; both substrates are immersed into NaOH (5% concentration) for 24 hrs for testing alkaliproof; both substrates are placed in a 400° C. environment for 1 hr for testing heat-resist; in a 175 g load RCA abrasion test, the microfilm coated substrate of the present invention can be scratched more than 200 times, but the anodizing processed substrate can only be scratched less than 80 times; in addition, both substrates are immersed into cooking oil for 24 hrs, and soy sauce for 24 hrs for testing anti oil stain, and the results are shown in Table 2:

TABLE 2

| | | the microfilm | the anodizing |
|---|---|---|---|
| | | coated | processed |
| Item | | substrate | substrate |
| hardness | | more than 8H | more than 4H |
| film thickness | | 3 μm | 10-50 μm |
| easy-to-clean | | easy | difficult |
| using detergent in process | | no | yes |
| environmental pollution | | very low | very high |
| anti-salt mist (500 hrs) | | pass | fail |
| solvent-resistant | ethanol | good | poor |
| | acetone | good | poor |
| | methyl ethyl | good | poor |
| | ketone | | |
| | toluene | good | poor |
| | Isopropyl | good | poor |
| | alcohol | | |
| acidproof | H2SO4 | pass | poor |
| alkaliproof | NaOH | pass | poor |
| heat-resist | | pass | poor |
| wear-resistant | | more than 200 times | less than 80 times |
| anti oil stain | cooking oil | pass | fail |
| | soy sauce | pass | fail |

From the table 2, it show the comparison results of the microfilm coated substrate according to the present invention and the anodizing processed substrate in different items. The performances of the microfilm coated substrate according to the present invention in the items of surface hardness, film thickness, using detergent in process, pollution, anti-salt mist, solvent-resistant, acidproof, alkaliproof, heat-resist, wear-resistant, and anti oil stain are far better than that of the anodizing processed substrate even if the film thickness of the microfilm coated substrate of the present invention is only 3 μm.

The previous description of the preferred embodiment is provided to further describe the present invention, not intended to limit the present invention. Any modification apparent to those skilled in the art according to the disclosure within the scope will be construed as being included in the present invention.

1. An inorganic microfilm coated substrate, comprising:
a substrate; and
an inorganic microfilm layer, disposed on the substrate and being an inorganic microfilm composition,
wherein the inorganic microfilm composition comprising:
a silicon oxide ion solution;
a lithium ion solution; and
a potassium ion solution,
wherein the silicon oxide ion solution, the lithium ion solution, and the potassium ion solution are mixed together to form the inorganic microfilm composition.

2. The inorganic microfilm coated substrate of claim 1, wherein the substrate comprises a material selected from a group consisting of aluminum (Al), magnesium (Mg), titanium (Ti), copper (Cu), iron (Fe), lithium (Li), glass, and ceramic.

3. The inorganic microfilm coated substrate of claim 1, wherein the lithium ion solution is Li4SiO4 solution.

4. The inorganic microfilm coated substrate of claim 3, wherein the Li4SiO4 solution is composed of SiO2 and Li2O.

5. The inorganic microfilm coated substrate of claim 4, wherein Young's modulus of SiO2 and the Li2O is between 2 and 12.

6. The inorganic microfilm coated substrate of claim 5, wherein Young's modulus of the SiO2 and the Li2O is preferably between 2 and 4.

7. The inorganic microfilm coated substrate of claim 1, wherein the potassium ion solution is K2SiO3 solution.

8. The inorganic microfilm coated substrate of claim 7, wherein the K2SiO3 solution is composed of the SiO2 and the K2O.

9. The inorganic microfilm coated substrate of claim 8, wherein Young's modulus of the SiO2 and the K2O is between 2 and 12.

10. The inorganic microfilm coated substrate of claim 9, wherein Young's modulus of the SiO2 and the K2O is preferably between 2 and 4.

11. The inorganic microfilm coated substrate of claim 4, wherein Young's modulus of the K2O and the Li2O is between 0.25 and 4.

12. The inorganic microfilm coated substrate of 10, wherein Young's modulus of the K2O and the Li2O is between 0.25 and 4.

13. The inorganic microfilm coated substrate of claim 1, wherein the inorganic microfilm composition further comprises a dye.

14. The inorganic microfilm coated substrate of claim 12, wherein the dye comprises a material selected from a group consisting of titanium, zinc oxide, carbon black, iron oxide black, manganese iron black, cobalt blue, copper phthalocyanine, iron blue, transparent iron oxide, cobalt green, iron oxide yellow, and iron oxide red.

15. A method for making an inorganic microfilm coated substrate, comprising:
providing the substrate of claim 1, and surface property of the substrate is modified by using an inorganic acid salt; and
providing the inorganic microfilm composition of claim 1, and the inorganic microfilm composition is coated on the substrate, and then baked to form an inorganic microfilm layer.

16. The method of claim 15, wherein the inorganic acid salt comprises a material selected from a group consisting of H3AlO3 and Silicate.
